(19) United States
(12) Patent Application Publication
(10) Pub. No.: US 2024/0369295 A1
(43) Pub. Date: Nov. 7, 2024

(54) LIQUID CARBON DIOXIDE SUBCOOLER

(71) Applicant: TOMCO2 SYSTEMS COMPANY, Loganville, GA (US)

(72) Inventor: HUGH SMITH, Rome, GA (US)

(21) Appl. No.: 18/656,208

(22) Filed: May 6, 2024

Related U.S. Application Data
(60) Provisional application No. 63/464,169, filed on May 4, 2023.

(51) Int. Cl. F25J 1/02; F25J 1/00

(52) U.S. Cl. CPC F25J 1/0262; F25J 1/0027; F25J 1/0254; F25J 2205/20; F25J 2290/34

(57) ABSTRACT

In an example aspect, a system for subcooling liquid carbon dioxide to be used for dry ice production comprises a refrigeration unit that includes cooling fluid within a cooling fluid circuit and a condenser to cool the cooling fluid. The system further comprises a heat exchanger connectable along a first fluid path between a liquid carbon dioxide source and dry ice production equipment via a liquid carbon dioxide supply line, the heat exchanger having a second fluid path connectable to the refrigeration unit via the cooling fluid circuit; wherein the heat exchanger maintains the first fluid path and the second fluid path adjacent to one another to facilitate heat exchange therebetween, and an outlet that outputs the liquid carbon dioxide to the dry ice production equipment and is in fluid communication with the heat exchanger through the liquid carbon dioxide supply line.

### CROSS-REFERENCE TO RELATED APPLICATIONS

The present application claims priority from U.S. Provisional Patent Application No. 63/464,169, filed on May 4, 2023, the disclosure of which is hereby incorporated by reference in its entirety.

### BACKGROUND

Solid carbon dioxide (“CO₂”) or dry ice has many commercial uses. For example, shipping companies will often use dry ice to keep an environment cold as an item, such as food, is transported. In addition, dry ice is used to not only chill or freeze food, but also to carbonate drinks. In an industrial setting, dry ice blasting is used to clean certain surfaces. The entertainment industry has also used dry ice for effects such as fog.

With the demand for dry ice growing in all of the listed industries, dry ice production has grown as well. A common practice is to store liquid CO₂ before making dry ice. Then, the temperature of the liquid CO₂ is lowered and then compressed using dry ice equipment such as a press. This process will produce CO₂ snow, which can take the form of blocks or ice pellets depending on the type of equipment used. The blocks or pellets can then be used for the various applications previously listed.

One challenge faced in making dry ice is keeping the liquid CO₂ cold while it moves along a fluid conduit from a storage tank to dry ice production equipment. In this example, the storage tank acts as a liquid carbon dioxide source. Dry ice producers cannot always position the liquid CO₂ tank near the dry ice production equipment due to available space. As a result, the liquid CO₂ will heat up slightly as it is channeled to the equipment, thus, resulting in a lower conversion rate of liquid CO₂ to snow and higher costs. Improvements in processes to efficiently maintain cooler liquid CO₂ are desired.

It is with respect to these and other general considerations that embodiments have been described.

### SUMMARY

In accordance with the present disclosure, the above and other issues are addressed by the following:

In a first aspect, a system for subcooling liquid carbon dioxide to be used for dry ice production comprises a refrigeration unit that includes cooling fluid within a cooling fluid circuit and a condenser to cool the cooling fluid. The system further comprises a heat exchanger connectable along a first fluid path between a liquid carbon dioxide source and dry ice production equipment via a liquid carbon dioxide supply line, the heat exchanger having a second fluid path connectable to the refrigeration unit via the cooling fluid circuit; wherein the heat exchanger maintains the first fluid path and the second fluid path adjacent to one another to facilitate heat exchange therebetween, and an outlet that outputs the liquid carbon dioxide to the dry ice production equipment and is in fluid communication with the heat exchanger through the liquid carbon dioxide supply line.

In a second aspect, a subcooler for subcooling liquid carbon dioxide to be used for dry ice production comprises a cooling fluid circuit and a refrigeration unit comprises a compressor fluidically connected along the cooling fluid circuit; and a condenser fluidically connected along the cooling fluid circuit. The subcooler further comprises a heat exchanger fluidically connected to the cooling fluid circuit, the heat exchanger having a separate fluid path therethrough in fluid communication with a liquid carbon dioxide flow path, the liquid carbon dioxide flow path being fluidically isolated from the cooling fluid circuit and positioned adjacent to the cooling fluid circuit to facilitate heat exchange therebetween, and an outlet downstream along the liquid carbon dioxide flow path, the outlet being configured to output cooled liquid carbon dioxide through the liquid carbon dioxide supply line to dry ice production equipment.

In a third aspect, a method for subcooling liquid carbon dioxide comprises receiving, at a heat exchanger, liquid carbon dioxide through a liquid carbon dioxide flow path, receiving, at the heat exchanger, cooling fluid through a cooling fluid circuit from a refrigeration unit, the cooling fluid circuit being separate from the liquid carbon dioxide supply line, wherein the refrigeration unit is used to cool the cooling fluid, flowing cooling fluid through the heat exchanger to perform heat exchange between the cooling fluid circuit and the liquid carbon dioxide supply line, the cooling fluid path being positioned proximate to the liquid carbon dioxide supply line within the heat exchanger, and outputting the cooled liquid carbon dioxide through the liquid carbon dioxide supply line to an outlet that is connected to the heat exchanger.

### BRIEF DESCRIPTION OF THE DRAWINGS

Non-limiting and non-exhaustive examples are described with reference to the following figures.

FIG. 1 illustrates an example environment with a subcooler apparatus.

FIG. 2 illustrates an example schematic diagram of a subcooler apparatus.

FIG. 3 illustrates an example system that includes a plurality of subcoolers;

FIG. 4 illustrates an example system including a remote subcooler in accordance with an example embodiment.

FIG. 5 illustrates an example user interface with a subcooler apparatus.

FIG. 6 illustrates an example operation graph of the refrigeration unit and associated subcooler.

FIG. 7 illustrates an example method to cool liquid CO₂.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims.

As briefly described above, embodiments of the present invention are directed to a subcooler system and apparatus that can be used to maintain a low temperature for liquid CO₂ as it flows from a supply to dry ice production equipment that converts the liquid CO₂ to a solid through various processes. Maintaining the liquid CO₂ temperature at a lower level, or lowering the temperature of the liquid CO₂ at a location proximate to the dry ice production equipment, results in a more dense/stable liquid to improve the conversion ratio from liquid to snow—when pressurized liquid carbon dioxide is injected into atmospheric conditions, which results in creation of snow and vapor. Such a process is often used for applications such as dry ice production and food freezing. A dry ice producer can also save in the amount of CO₂ usage due to an improved conversion ratio (the amount of liquid converted to dry ice rather than being vented off as gaseous carbon dioxide). The subcooler may include various components such as a heat exchanger and refrigeration unit to cool the liquid CO₂. In some embodiments the heat exchanger and refrigeration are separate, which provides the additional benefit of providing cooling away from the refrigeration unit that can occupy a large space and need to be in a ventilated environment.

One potential subcooler solution is proposed in U.S. Publication No. 2022/0136783, the disclosure of which is fully incorporated herein. In that disclosure, a subcooling process utilizes a second tap from the liquid CO₂ supply to inject the liquid into a container that also routes a coil supply of liquid CO₂ therethrough. The coil of liquid CO₂ supply exchanges heat with a CO₂/glycol bath that fills the container. The glycol mixture is kept cold using a tap into the liquid CO₂ supply line, and thus, the coil of liquid CO₂ supply exits such a subcooler at a lower temperature at a location proximate to dry ice production equipment than may otherwise be achieved.

The present disclosure provides additional methods and structures for providing subcooling of liquid CO₂ supply, including those which do not use the liquid CO₂ supply itself as a mechanism for cooling the liquid CO₂ delivered to the dry ice production equipment. As such, subcooling may be accomplished with minimized loss of liquid CO₂. Furthermore, the embodiments discussed herein are well-adapted to continuous or near-continuous operation for bulk dry ice production, as compared to previous methods.

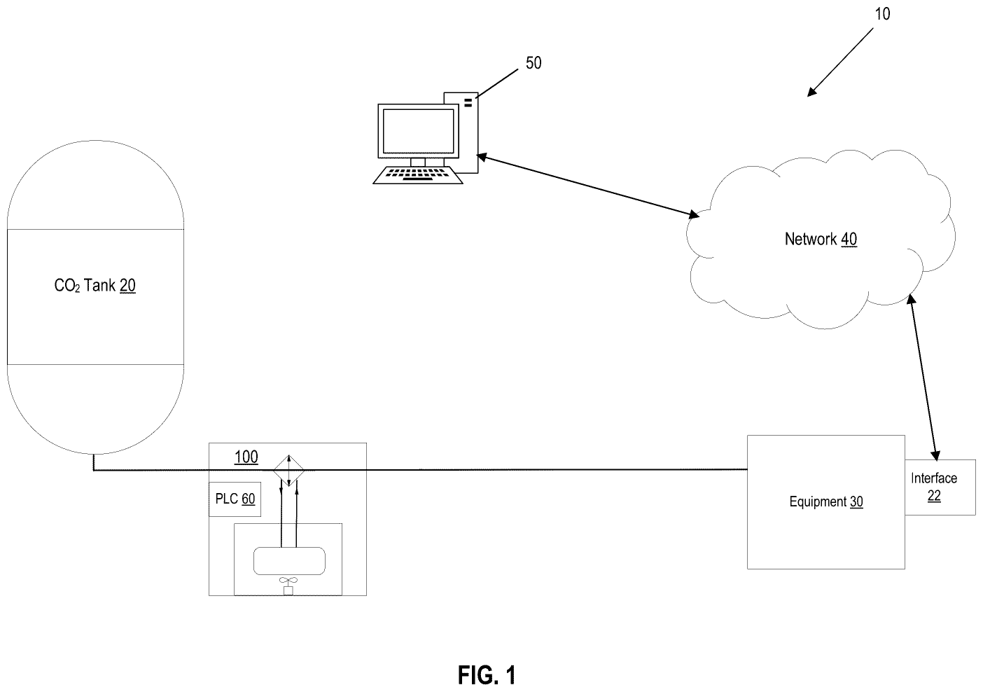

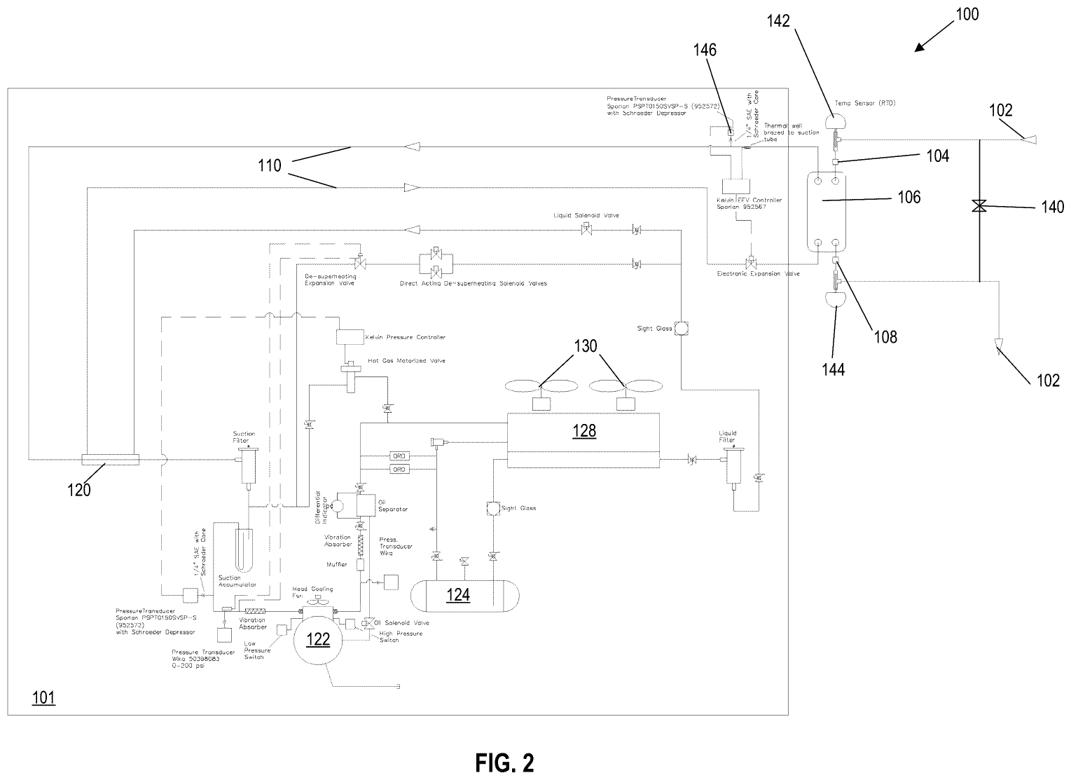

FIG. 1 illustrates an example system that includes a subcooler apparatus. The system 10 may be an overall system for production of dry ice, and includes CO₂ tank 20 that fluidically connects to subcooler apparatus 100 through a supply line so that liquid CO₂ can flow from tank 20 to apparatus 100 and then to dry ice production equipment 30. While the liquid CO₂ flows through apparatus 100, it is cooled through a heat exchanger. Subcooler apparatus 100 further includes a refrigeration unit/system which may include some or all of the components shown in FIG. 2. Apparatus 100 also includes programmable logic controller unit (“PLC”) 60 to control subcooler apparatus 100.

In this embodiment, CO₂ tank 20 is a cryogenic tank that keeps the CO₂ at low temperatures and under pressure (e.g., to maintain bulk CO₂ in liquid form). In addition to a CO₂ tank, other storage containers can be used as well in other embodiments. Further, the tank may also be of varying sizes that can store the liquid CO₂ at an appropriate temperature while it is not being used. Further, equipment 30 may include a dry ice block press, dry ice pellet production equipment, a hydraulic power unit or hybrid unit, CO₂ snow making equipment such as a snow hood, or other kinds of dry ice production equipment. Although in some instances described herein as a brazed plate heat exchanger, the heat exchanger included in the apparatus 100 may also be implemented using different types of heat exchangers in different embodiments as explained below. The refrigeration system within subcooler apparatus 100 may be a commercial air refrigeration unit used to cool buildings. In the illustrated example, the heat exchanger and refrigeration system are combined.

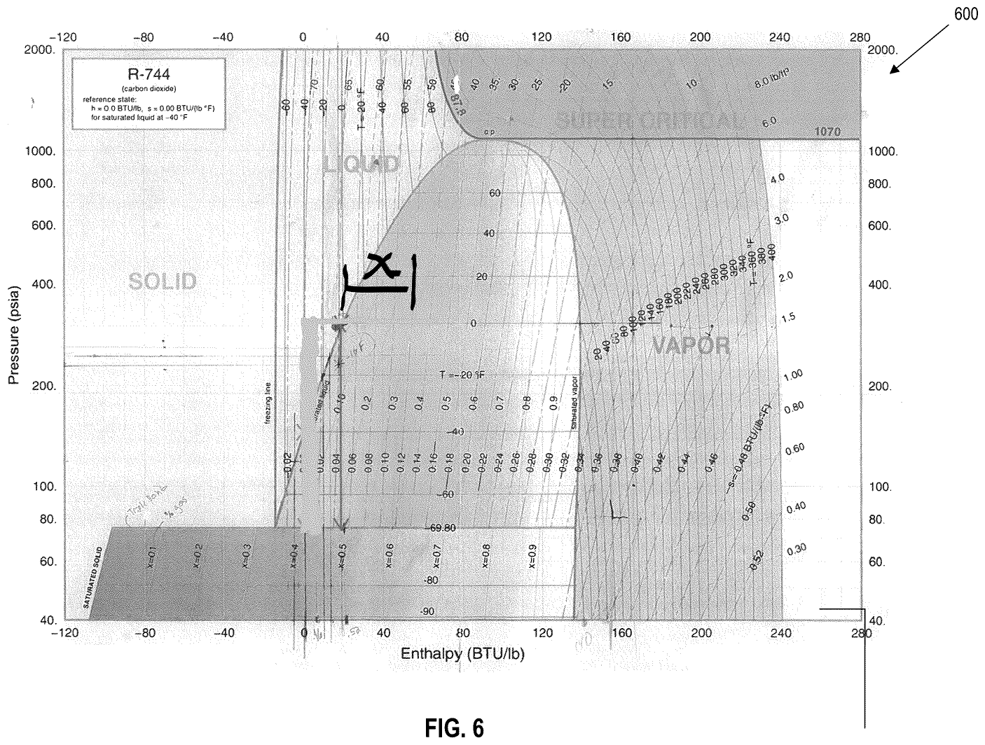

Interface 22 also communicatively connects with the sensors and valves associated with subcooler apparatus 100. Through this interface 22, a user is able to see the status of the system. For example, interface 22 will show if the system is OK/running properly or if it is powered on. In other embodiments, interface 22 will include various pressures and temperatures as described in association with FIG. 6. In the illustrated embodiment, interface 22 also connects to network 40 to provide access to the described data to computing system 50. Interface 22 may connect to network 40 over a wired connection such as ethernet or coaxial connection. In other embodiments, interface 22 connects to network 40 over wireless means such as a LAN, WLAN, cellular network, Wi-Fi, or Bluetooth through an intermediary device. This connection allows interface 22 to transmit data to computing device 50 so that a user can remotely monitor subcooler apparatus 100. If apparatus 100 were to fail, a user would be quickly notified and a technician can be dispatched to fix apparatus 100. Computing device 50 includes a mobile phone, desktop, laptop, tablet, or any other computing device.

FIG. 2 illustrates an example schematic diagram of subcooler apparatus 100. Subcooler apparatus 100 includes heat exchanger 106 that fluidically connects to refrigeration unit 101. Refrigeration unit 101 further includes compressor 122 and condenser 128 among other components. Subcooler apparatus 100 further includes liquid CO₂ supply line 102, which may also be referred to as flow path 102. Supply 102 allows liquid CO₂ to flow into input 104 that connects to heat exchanger 106 where the liquid CO₂ is cooled. The liquid CO₂ is output through outlet 108 and continues through liquid CO₂ supply line (example routing within the context of dry ice formation shown in FIG. 2). Further, the liquid CO₂ flows through temperature sensors 142 as it enters heat exchanger 106 and then flows through temperature sensor 144 as it exits heat exchanger 106.

In this embodiment, heat exchanger 106 has a separate fluid circuit carrying a cooling fluid via a cooling circuit 110, or also known as a cooling fluid flow path. The cooling circuit 110 provides fluid communication, or also called allowing fluid to flow, between connected components to flow cooling fluid for facilitating heat exchange with the liquid CO₂. Cooling circuit 110 is fluidically connected to suction heat exchanger 120 to further exchange heat among fluids that are within subcooler apparatus 100. Further, compressor 122 fluidically connects to the cooling circuit 110 to pressurize the fluid and help move the cooling fluid through the circuit and to various components. Other components that are fluidically connected to the cooling fluid circuit also include receiver 124 that then connects to condenser 128. Condenser 128 cools the cooling fluid within cooling fluid circuit 110 using fans 130, that then flows back to heat exchanger 106. Other components may be included as well as shown in FIG. 2.

In the shown example embodiment, liquid CO₂ flows into input 104 at approximately 300 psi and 0° F. The liquid CO₂ then enters heat exchanger 106. In this embodiment, heat exchanger 106 is a brazed plate heat exchanger. Other embodiments may use different heat exchangers such as spiral heat exchangers, tube within a tube heat exchangers, or any other type of heat exchanger that can exchange heat between two fluids. Using the heat exchanger, the liquid carbon dioxide flows into a various number of chambers within heat exchanger 106 and the cooling fluid will flow into adjacent chambers, thus, allowing heat to be exchanged through the plates.

Downstream of the heat exchanger 106, the liquid CO₂ will continue flowing to outlet 108 and through supply line 102. Supply line 102 enables fluid communication, or fluids to flow based on a pressure differential, between the connected components. As it exits heat exchanger 106, the liquid carbon dioxide is still at approximately 300 psi and has lowered in temperature to −20° F. During heat exchange, the cooling fluid is heated by absorbing the heat from the liquid carbon dioxide where some or all of the cooling fluid may evaporate into a gas from receiving the transferred heat. In other embodiments, the liquid carbon dioxide is cooled to different cryogenic temperatures.

In the illustrated example, liquid carbon dioxide enters input 104 at a pressure of 300 psi as previously mentioned. The liquid carbon dioxide may also exit at approximately 300 psi, which is the same pressure it entered heat exchanger 106. However, other pressures may be used; generally speaking, a pressure above atmospheric pressure is employed, such that a reduction in temperature at dry ice production equipment 30 facilitates production of dry ice. In example embodiments, the same pressure is maintained along the supply line 102, including through the subcooler apparatus 100. Thus, subcooler apparatus 100 is capable of operating with a wide range of pressures.

Regardless of the pressure the liquid carbon dioxide enters heat exchanger 106, it will exit at approximately the same temperature and apparatus 100 will still function in a similar way. Differing scenarios may operate and store the liquid CO₂ at different pressures and this may not be known until after installation of subcooler apparatus 100. To handle liquid CO₂ systems that operate at different pressures, subcooler apparatus 100 is able to receive pressurized CO₂ and output the pressurized CO₂ at the same pressure as the input with the same or substantially the same components in subcooler apparatus 100 and the same or similar operation. While 300 psi is used herein by way of example, as noted previously, other pressures are possible as well that are above atmospheric pressure or 1 atm.

Cooling fluid circuit 110 may be of varying lengths depending on how far heat exchanger 106 is from the rest of the subcooling apparatus. In some embodiments, the heat exchanger is above condensing unit 128 so the suction line drains freely back to compressor 122. In other embodiments, it is in a remote location. In the shown embodiment suction heat exchanger 120 helps cool the cooling fluid using a secondary circuit that may use a fluid such as water or air. Compressor 122 controls the pressure of the cooling fluid to transport the cooling fluid through subcooler apparatus 100. One example of a compressor that may be used in subcooler apparatus 100 include a Copeland 6DUNF13ME, though other embodiments may use other types of compressors.

In the example shown, receiver 124 stores cooling fluid that then moves to condenser 128 where the fluid changes to a liquid form by cooling from fans 130. Cooling fluid can then continue through circuit 110 back to heat exchanger 106 to cool the liquid CO₂. This apparatus allows for cooling liquid CO₂ using a separate cooling fluid that is part of a different flow path/circuit such as via cooling circuit 110. Cooling fluid may be propane, ammonia, carbon dioxide, glycol, ammonia, or some other type of heat transfer fluid.

Apparatus 100 also includes temperature sensors 142 and 144 to detect the temperature of the liquid CO₂ as it flows. Sensor 142 will detect the temperature before it flows into heat exchanger 106 and sensor 144 will detect the temperature after the CO₂ has been cooled by heat exchanger 106. Further, both or one of the sensors may transmit the detected temperature to interface 22. In addition, pressure transducers/sensor are included to measure the suction pressure and discharge pressure of the cooling fluid within cooling circuit 110, such as transducer 146 that is operable to measure one or both of the suction and discharge pressures, and then transmit to an interface or PLC. A programmable logic unit, discussed above, may also be included to control subcooler apparatus 100. However, refrigeration unit 101 may encompass other components and be a different type of cooling unit that comprises a compressor and a condenser and separates the liquid carbon dioxide flow path 102 from the cooling fluid circuit 110.

Other components shown but are not discussed in detail in this application may include various valves, such as solenoid or motorized, sight glass, pressure transducers, vibration absorbers, and oil separators among other parts. Some or all of these components may be housed in a commercial refrigeration unit such as refrigeration unit 101. This type of refrigeration unit may often be used to cool buildings. Heat exchanger 106 is then attached or connected to the commercial refrigeration unit to form subcooler apparatus 100. In other embodiments, the refrigeration unit may omit, add, or change some of the components previously listed. Using a cooling unit, such as refrigeration unit 101, to lower the temperature of the cooling circuit 110 as separate from liquid carbon dioxide flow path 102 allows subcooler apparatus 100 to continuously cool liquid carbon dioxide and operate without pausing as opposed to using a portion of the liquid carbon dioxide from the supply of flow path 102. Using part of the supply liquid CO₂ may often require a pause in operation, slow down production, and cost CO₂.

Additionally, subcooler apparatus 100 includes bypass 140. In situations such as when apparatus 100 needs to be repaired, the system is bypassed by routing the liquid CO₂ through bypass 140 so the liquid CO₂ can continue to flow through supply 102. Bypass 140 includes a valve that can change state to control when liquid CO₂ flows through bypass 140. In alternative embodiments, bypass 140 is omitted.

In the illustrated embodiment, refrigeration unit 101 is shown as a separate unit from heat exchanger 106. However, heat exchanger 106 may also be located within or attached to refrigeration unit 101. Further, heat exchanger 106 is located at a remote location that is a distance away from refrigeration unit 101 as discussed below for a different embodiment. Also, refrigeration unit 101 is a commercial refrigeration unit that can be used to cool buildings in some embodiments. In alternative embodiments, refrigeration unit 101 comprises an ammonia circuit that is often used in food processing. Many of the components may be changed to be appropriate for use with ammonia as the cooling fluid within cooling circuit 110 such as a compressor and condenser compatible with ammonia. Other possible arrangements for refrigeration unit 101 are also possible to cool liquid CO₂ as it flows from one source to a destination.

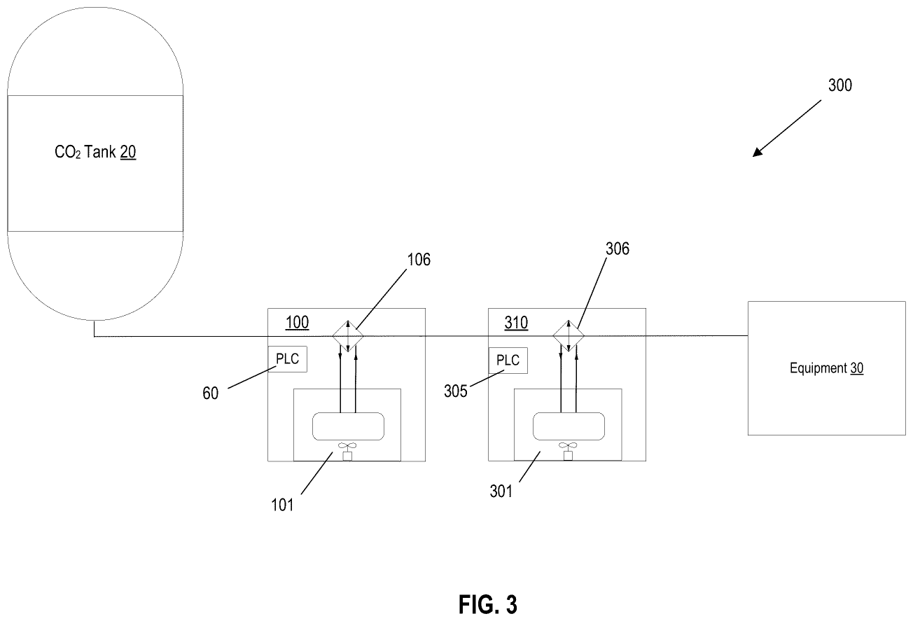

FIG. 3 illustrates an alternative example subcooler system that includes an additional subcooler apparatus. Subcooling system 300 includes similar components as subcooling system 10. However, it includes subcooler apparatus 310 that is also connected to the liquid CO₂ supply line. In the shown embodiment, subcooler apparatus 310 include the same or similar types of components as subcooler apparatus 100. As the liquid CO₂ is cooled and leaves subcooler apparatus 100, it then enters subcooler apparatus 300. Next the liquid CO₂ is further cooled by heat exchanger 306. The liquid CO₂ then continues to equipment 30. This alternative embodiment may provide more cooling when the distance between tank 20 and equipment 30 is of greater length. Apparatus 100 further includes programmable logic controller unit 60 to control the refrigeration unit 101 and valves connected to heat exchanger 106. PLC 305 is also the same as PLC 60 in this embodiment, but may be a different type of controller in different embodiments. In other embodiments, some components may be added, omitted, or changed to subcooler apparatus 100 and 310.

In the shown embodiment, PLC 60 is programmed to automatically control subcooler apparatus 100. PLC 60 will control the cooling based on actual usage to help minimize CO₂ usage. FIG. 1. In addition, PLC 60 can be programmed to control refrigeration unit 101 and control valves that control the flow of the liquid carbon dioxide through supply 102 such as the valve within bypass 140. PLC 60 may also receive inputs from pressure sensors and temperature sensors such as temperature sensors 142 and 144, and communicate them to interface 22. However, subcooler apparatus 100, 200, and 300 can be controlled manually in other embodiments, and PLC 60 may be omitted. Different types of PLCs that can be used as PLC 60 may be modular PLCs, compact PLCs, and integrated PLCs. In other embodiments, PLC may control other components of subcooling system 200 as well such as flow of the cooling circuit or liquid carbon dioxide flow path. In alternative embodiments, a different controller is used such as a microcontroller or microcomputer, such as a single-board computer, or other types of programmable chips that can receive inputs and control outputs.

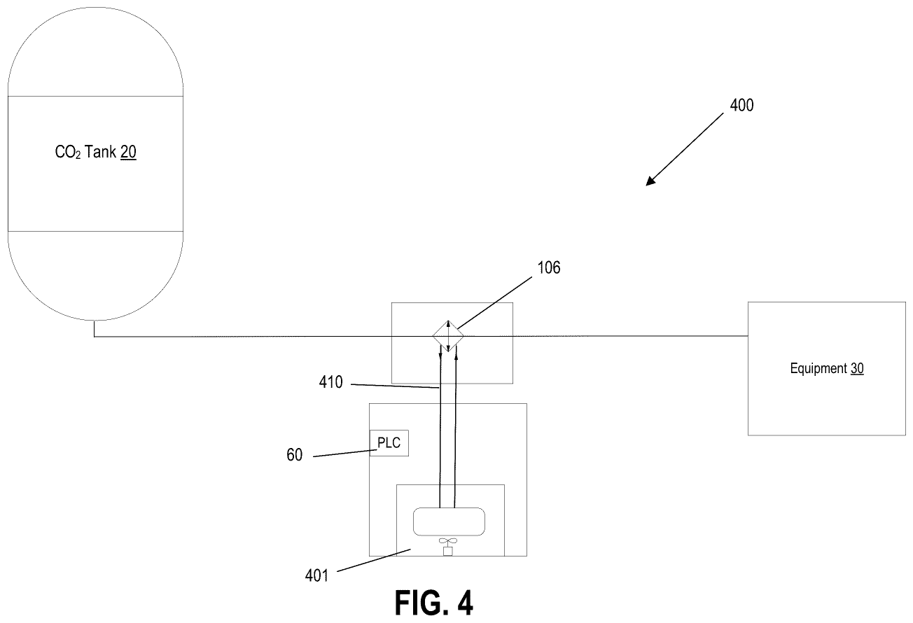

FIG. 4 illustrates an alternative example subcooler system. In this alternative embodiment, heat exchanger 106 is positioned away from refrigeration unit 401 and PLC 60. In this embodiment, refrigeration unit 401 is the same as refrigeration unit 101 but its cooling circuit is extended to reach a remote location. In some instances, cooling equipment will be located outside in a large space because the of the volume equipment takes up. Further, equipment 30 may be located inside or at a remote location. Therefore, the supply line from tank 20 to equipment 30 may not cross the path of a convenient location for refrigeration unit 401. In this embodiment, heat exchanger 106 is located at a remote location that may be more convenient for cooling the liquid CO₂. As shown cooling fluid circuit 410 can extend to a remote location to facilitate the cooling at heat exchanger 106. Other configurations for heat exchanger 106 and refrigeration unit 408 can be appreciated from the disclosed designs.

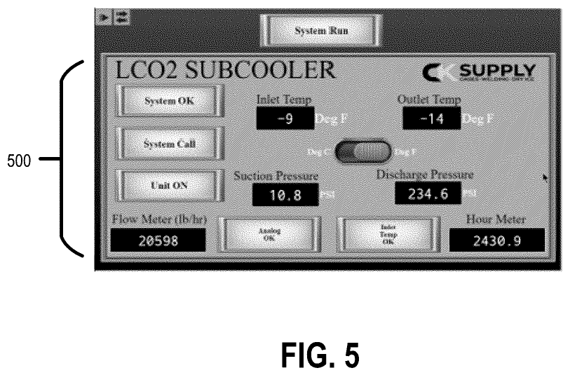

FIG. 5 illustrates an example user interface 500 connected to a subcooler system. User interface 500 includes status displays. In this embodiment, the status display includes the inlet temperature for liquid CO₂ and outlet temperature, thus, providing information to the user on how well the system is cooling the liquid CO₂ in this embodiment. Also, suction pressure and discharge pressure of the cooling circuit within the refrigeration unit are shown. It is noted that the inlet temperature, outlet temperature, suction pressure, and discharge pressure may be monitored using one or more sensors positioned within or proximate to a subcooler apparatus, such as the subcooler apparatus 100 described herein.

In other embodiments, the units may be changed such as to Kelvin or Celsius for temperature and pascals for pressure. In still other embodiments, additional information such as temperature of the cooling fluid circuit may be provided as well or different statues and controls may be omitted or changed. In an alternative embodiment, the display may include controls that can program refrigeration unit 101 or the entire subcooler apparatus 100. Though not shown, these controls link to PLC 60 in this embodiment, however, they may link to some other programmable control unit as well. Further, user interface 500 may be attached to the subcooler apparatus 100 as shown in FIG. 1. In other embodiments, user interface 500 is displayed on a smart device such as a mobile phone, tablet, or other mobile computing device with a display by transmitting data through a network. User interface 500 can also be accessed via a computer in still other embodiments onsite or remotely.

FIG. 6 illustrates an example operation graph 600 illustrating target operational features of the subcooler apparatus. In this example, it provides operational enthalpy or heat content vs. pressure for carbon dioxide. Further, sections of the graph are provided to indicate at what state carbon dioxide will take based on its heat content and pressure. It can be appreciated different operation temperatures can be achieved for proficient performance of subcooler apparatus 100 and the shown graph is not to be seen as limiting.

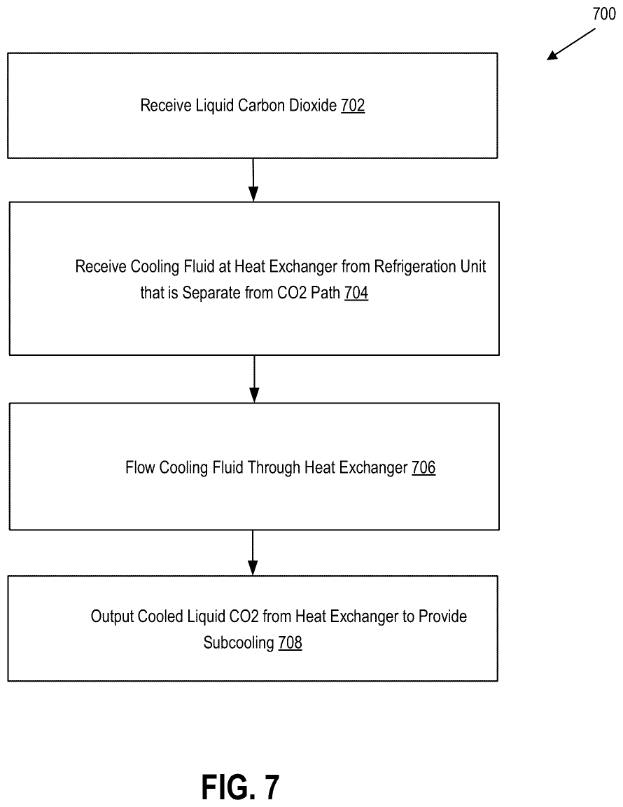

FIG. 7 illustrates an example method to cool liquid CO₂. In this embodiment, method 700 includes operations 702-708. These steps or operations may execute in sequential order or in a different order. Moreover, some operations may change or be omitted while additional operations may be added in alternative embodiments. Method 700 can be accomplished with the subcooling systems and apparatuses previously disclosed in FIGS. 1-6.

At operation 702, liquid carbon dioxide is received at a heat exchanger through a liquid carbon dioxide flow path. In some embodiments, the heat exchanger is heat exchanger 106 and liquid carbon dioxide flow path is supply line 102.

At operation 704, the feature of receiving, at the heat exchanger, cooling fluid through a cooling fluid circuit from a refrigeration unit, the cooling fluid circuit being separate from the liquid carbon dioxide flow path, wherein the refrigeration unit is used to cool the cooling fluid is accomplished.

At operation 706, the feature of flowing cooling fluid through the heat exchanger to perform heat exchange between the cooling fluid circuit and the liquid carbon dioxide flow path, the cooling fluid path being positioned proximate to the liquid carbon dioxide flow path within the heat exchanger is accomplished. In this embodiment, the flow path and cooling circuit are positioned relative to each other so that heat principals cause heat to flow from the warmer fluid with a higher temperature to the cooler fluid with a cooler temperature. In some embodiments, operation 806 includes lowering the liquid CO₂ to −35° F.

At operation 708, the step of outputting the cooled liquid carbon dioxide through the liquid carbon dioxide flow path to an outlet that is connected to the heat exchanger is accomplished.

In other embodiments, method 700 may include additional operations of delivering the liquid CO₂ to an additional subcooling apparatus that further cools the liquid CO₂. Additional features may then be accomplished which includes receiving at a second heat exchanger the liquid carbon dioxide; cooling, at the second heat exchanger, the liquid carbon dioxide; outputting the cooled liquid carbon dioxide; receiving from a second subcooling apparatus, a second cooling fluid within a second cooling fluid circuit that connects to the second heat exchanger; and exchanging, at the second heat exchanger, heat between the liquid carbon dioxide and the second cooling fluid. It may also include delivering the CO₂ to dry ice production equipment, which is then used to produce CO₂ snow or also known as dry ice from the liquid CO₂. Additional embodiments may include a PLC that is configurable to cause all or some of the operations. Other operations may comprise producing dry ice from the liquid carbon dioxide using dry ice production equipment 30.

The present disclosure is not to be limited in terms of the particular embodiments described in this application, which are intended as illustrations of various aspects. Many modifications and variations can be made without departing from its spirit and scope. Functionally equivalent methods and systems within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only, and is not intended to be limiting.

The above specification, examples and data provide a complete description of the use of the invention. Since many embodiments of the invention can be made without departing from the spirit and scope of the invention, the invention resides in the claims hereinafter appended.

What is claimed is:

1. A system for subcooling liquid carbon dioxide to be used for dry ice production, the system comprising:
a refrigeration unit that includes cooling fluid within a cooling fluid circuit and a condenser to cool the cooling fluid;
a heat exchanger connectable along a first fluid path between a liquid carbon dioxide source and dry ice production equipment via a liquid carbon dioxide supply line, the heat exchanger having a second fluid path connectable to the refrigeration unit via the cooling fluid circuit; wherein the heat exchanger maintains the first fluid path and the second fluid path adjacent to one another to facilitate heat exchange therebetween; and
an outlet that outputs the liquid carbon dioxide to the dry ice production equipment and is in fluid communication with the heat exchanger through the liquid carbon dioxide supply line.

2. The system of claim 1, wherein the heat exchanger comprises a brazed plate heat exchanger.

3. The system of claim 1, further comprising a programmable logic controller unit that is configurable to control the flow of the liquid carbon dioxide supply line and cooling amount of the liquid carbon dioxide.

4. The system of claim 1, wherein the heat exchanger is positioned within a housing including the refrigeration unit.

5. The system of claim 1, further comprising a second heat exchanger fluidically connected along the liquid carbon dioxide supply line, the second heat exchanger being positioned downstream of the heat exchanger to receive the liquid carbon dioxide output from the heat exchanger, provide further cooling of the liquid carbon dioxide, and output the cooled liquid carbon dioxide to the outlet.

6. The system of claim 5, further comprising a second refrigeration unit fluidically connected to the second heat exchanger via a second coolant circuit.

7. The system of claim 1, wherein the liquid carbon dioxide is received at the outlet at approximately −35° F.

8. The system of claim 1, further comprising the liquid carbon dioxide source, wherein the liquid carbon dioxide source comprises a bulk liquid carbon dioxide storage tank.

9. The system of claim 1, further comprising the dry ice production equipment, wherein the dry ice production equipment comprises a snow hood.

10. A subcooler for subcooling liquid carbon dioxide to be used for dry ice production, the subcooler comprising:
a cooling fluid circuit;
a refrigeration unit comprising:
a compressor fluidically connected along the cooling fluid circuit; and
a condenser fluidically connected along the cooling fluid circuit;
a heat exchanger fluidically connected to the cooling fluid circuit, the heat exchanger having a separate fluid path therethrough in fluid communication with a liquid carbon dioxide flow path, the liquid carbon dioxide flow path being fluidically isolated from the cooling fluid circuit and positioned adjacent to the cooling fluid circuit to facilitate heat exchange therebetween; and
an outlet downstream along the liquid carbon dioxide flow path, the outlet being configured to output cooled liquid carbon dioxide through the liquid carbon dioxide flow path to dry ice production equipment.

11. The subcooler of claim 10, wherein:
the compressor is configured to compress cooling fluid within the cooling fluid circuit to facilitate movement of the cooling fluid through the cooling fluid circuit; and
the condenser is configured to condense the cooling fluid into a liquid and cool the cooling fluid.

12. The subcooler of claim 10, wherein the heat exchanger comprises a brazed plate heat exchanger.

13. The subcooler of claim 10, further comprising a second heat exchanger in the liquid carbon dioxide flow path that receives the liquid carbon dioxide from the heat exchanger, further cools the liquid carbon dioxide, and outputs the cooled liquid carbon dioxide to a second outlet.

14. The subcooler of claim 10, wherein cooling fluid, within the cooling fluid circuit, comprises at least one of propane, ammonia, carbon dioxide, or glycol.

15. The subcooler of claim 10, further comprising a programmable logic controller unit that is configurable to control the flow of the liquid carbon dioxide flow path and cooling amount of the liquid carbon dioxide.

16. A method for subcooling liquid carbon dioxide, the method comprising:
receiving, at a heat exchanger, liquid carbon dioxide through a liquid carbon dioxide flow path;
receiving, at the heat exchanger, cooling fluid through a cooling fluid circuit from a refrigeration unit, the cooling fluid circuit being separate from the liquid carbon dioxide flow path, wherein the refrigeration unit is used to cool the cooling fluid;
flowing cooling fluid through the heat exchanger to perform heat exchange between the cooling fluid circuit and the liquid carbon dioxide flow path, the cooling fluid path being positioned proximate to the liquid carbon dioxide flow path within the heat exchanger; and
outputting the cooled liquid carbon dioxide through the liquid carbon dioxide flow path to an outlet that is connected to the heat exchanger.

17. The method of claim 16, wherein the heat exchanger comprises a brazed plate heat exchanger.

18. The method of claim 14, further comprising controlling, with a programmable logic unit included at the refrigeration unit, the flow of the liquid carbon dioxide flow path and cooling amount of the liquid carbon dioxide.

19. The method of claim 14, further comprising:
receiving at a second heat exchanger the liquid carbon dioxide;
cooling, at the second heat exchanger, the liquid carbon dioxide; and
outputting the cooled liquid carbon dioxide.

20. The method of claim 17, further comprising producing dry ice from the liquid carbon dioxide at dry ice production equipment fluidically connected to the outlet.
